(19) United States
(12) Patent Application Publication
(10) Pub. No.: US 2022/0371718 A1
(43) Pub. Date: Nov. 24, 2022

(54) GAS REPLACEMENT SYSTEM

(71) Applicant: Pioneer Astronautics, Lakewood, CO (US)

(72) Inventors: Robert Zubrin, Lakewood, CO (US); Mark Berggren, Lakewood, CO (US)

(21) Appl. No.: 17/750,120

(22) Filed: May 20, 2022

Related U.S. Application Data
(60) Provisional application No. 63/190,971, filed on May 20, 2021.

(51) Int. Cl. B64B 1/62; B64B 1/64; B64B 1/70; B64B 1/40

(52) U.S. Cl. CPC B64B 1/62; B64B 1/64; B64B 1/70; B64B 1/40

(57) ABSTRACT

Gas Replacement System (GRS) produces lighter than air lift gas from ammonia to enable balloon launch and/or to extend the flight durations of balloons. The GRS produces lighter than air lift gas by dissociating all or part of an ammonia supply into a mixture of nitrogen and hydrogen. The GRS can be used to launch balloons from the ground and/or produce gas for airborne balloons to extend their flight duration. In one embodiment, a GRS includes a tank containing ammonia (e.g., liquid ammonia), a reactor, and a controller operable to direct a release of the ammonia from the tank to the reactor. The controller is also operable to direct the reactor to dissociate at least a portion of the ammonia into a lift gas and exhaust the lift gas from the reactor into the balloon for inflation, the lift gas comprising nitrogen and hydrogen.

### CROSS REFERENCE TO RELATED APPLICATIONS

This patent application is a non-provisional patent application claiming priority to, and thus the benefit of an earlier filing date from, U.S. Provisional Patent Application No. 63/190,971 (filed May 20, 2021), the entire contents of which are hereby incorporated by reference.

### GOVERNMENT LICENSE RIGHTS

This invention was made with government support under NASA Contract No. 80NSSC20C0269. The government has certain rights in the invention.

### BACKGROUND

Super Pressure Balloons (SPBs) are aerostatic balloons that have their volumes kept relatively constant in spite of changes in ambient pressure outside the balloon and temperature changes of the lifting gas inside the balloon. For example, SPBs are generally strong enough to contain extra pressure in a balloon that is generated by solar flux in the daytime. And, for this reason, SPBs do not need to vent gas.

Since SPBs do not vent gas in the daytime, SPBs do not need to drop ballast in the following night. As a result and in contrast to zero pressure balloons which must continually alternate between venting gas and dropping ballast, SPBs require almost no consumables (e.g., mass) to maintain flight. Theoretically, an ideal SPB could continue to fly forever. Unfortunately, however, SPBs are complex structures that contain seams and fittings that can leak. The lifting gas can also permeate through the thin balloon envelope itself. So, the effect of this leakage needs to be counteracted if level flight is to be maintained.

Consider NASA's SuperTIGER which supports a 2700 kg cosmic ray observatory flying at an altitude of 39 km. The balloon, which is nearly spherical in shape has a radius of 70 m. Assuming a spherical approximation, the balloon has an area of 61,544 m² and a volume of 1,436,027 m³. According to standard atmosphere tables, air has a density of 4.6112 gm/m³ at 39 km. Under the same conditions helium has a density of (4/29)(4.6112)=0.636 gm/m³. The total buoyancy produced by the balloon is its volume times the difference between air density and helium density, or (1,436,027)(4.6112−0.636)=5,708,494.5 gms=5708.5 kg. This 5708.5 kg of buoyancy must support the 2700 kg gondola plus the balloon and other flight systems, which leaves 3008 kg available to support the latter purposes. The total mass of helium in the balloon is 913 kg, while the total air it displaces (i.e. total system floating mass) is 6,621 kg.

If the balloon starts to leak helium at a rate of 2% per week, it loses 10% of its helium after 5 weeks. If the helium is not replaced, a loss of buoyancy of 571 kg will occur since the total buoyancy is the difference between the mass of helium in the balloon and the air it displaces. Thus, the balloon will descend and keep descending until it hits ground, because even though the air is denser at lower altitudes the higher pressure will cause the balloon to contract.

Dropping 571 kg of ballast can offset the lost 571 kg of buoyancy. But now, with 10% less helium remaining, the balloon will ascend to an altitude with 10% lower pressure, which in this example would be 39,800 m. So, at a cost of 571 kg of ballast, flight is maintained, albeit at an altitude 800 m higher than the design altitude. And, the total floating mass of the system is decreased by 91 kg of helium+571 kg of ballast, which equals 662 kg, or 10% of the original total.

### SUMMARY

Systems and method herein provide for a Gas Replacement System (GRS), which produces lighter than air lift gas from ammonia to enable a balloon launch from ground and/or to extend the flight duration of an airborne balloon. The GRS produces lighter than air lift gas by dissociating all or part of an ammonia supply into a mixture of nitrogen, hydrogen, and ammonia. In one embodiment, a GRS includes a tank containing ammonia (e.g., liquid ammonia), a reactor, and a controller operable to direct a release of the ammonia from the tank to the reactor. The controller is also operable to direct the reactor to dissociate at least a portion of the ammonia into a lift gas and exhaust the lift gas from the reactor into the balloon for inflation, the lift gas comprising nitrogen and hydrogen. In some embodiments, the GRS includes a heater (e.g., an electric heater, a combustion heater, or the like) to heat the reactor (e.g., catalytic reactor) to dissociate said at least a portion of the ammonia into the lift gas.

In some embodiments, the GRS includes a heat exchanger operable to heat the ammonia from the tank with heated gas from the reactor prior to dissociation of the ammonia by the reactor. In some embodiments, the GRS includes a separation membrane that removes a portion of the nitrogen from the lift gas to configure the lift gas with a molar ratio of greater than about 3 to 1 of hydrogen to nitrogen, respectively. In some embodiments, the GRS includes a power supply comprising one or more of a generator, a solar panel, or a battery to power at least one of the controller, a heater of the reactor, or a payload.

In some embodiments, the GRS includes a valve physically coupled between the tank and the reactor and communicatively coupled to the controller. And, the controller is operable to open the valve to release the ammonia from the tank to the reactor. In some embodiments, the controller is operable to control pressure within the GRS by controlling one or more valves of the GRS.

In some embodiments, the GRS includes an altimeter operable to detect an altitude of the balloon. And, the controller is operable to direct the reactor to dissociate said at least a portion of the ammonia into the lift gas based on the detected altitude of the balloon. In some embodiments, the GRS includes a pressure sensor operable to detect a pressure within the balloon. And, the controller is further operable to direct the reactor to dissociate said at least a portion of the ammonia into the lift gas based on the detected pressure within the balloon. In some embodiments, the controller is further operable to direct the reactor to dissociate said at least a portion of the ammonia into the lift gas before the balloon takes flight.

The various embodiments disclosed herein may be implemented in a variety of ways as a matter of design choice. For example, some embodiments herein are implemented in hardware whereas other embodiments may include processes that are operable to implement and/or operate the hardware. Other exemplary embodiments, including software and firmware, are described below.

### BRIEF DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of one exemplary GRS using an NH₃ dissociation to provide a replacement gas.

FIG. 2 is another block diagram of the exemplary GRS.

FIG. 3 is a graph illustrating the effect of an exemplary ammonia feed rate on dissociation of the GRS.

FIG. 4 is a block diagram of the GRS illustrating exemplary operating conditions during a ground launch.

FIG. 5 illustrates an actual flight ground track of a balloon configured with a GRS.

FIG. 6 is a graph illustrating the balloon altitude and speed during the flight.

FIG. 7 is a flowchart of an exemplary process operable with the GRS.

FIG. 8 is a block diagram of an exemplary computing system in which a computer readable medium provides instructions for performing methods herein.

### DETAILED DESCRIPTION

The figures and the following description illustrate specific exemplary embodiments. It will thus be appreciated that those skilled in the art will be able to devise various arrangements that, although not explicitly described or shown herein, embody certain principles and are included within the scope of the embodiments. Furthermore, any examples described herein are intended to aid in understanding the embodiments and are to be construed as being without limitation to such specifically recited examples and conditions. As a result, the embodiments are not limited to any of the examples described below.

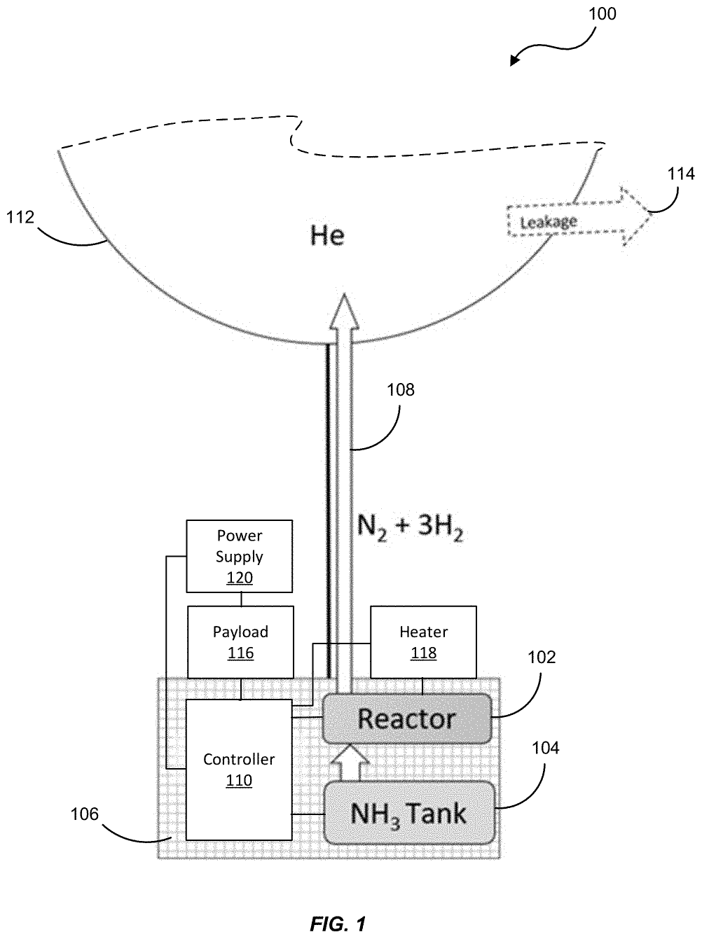

FIG. 1 is a block diagram of one exemplary Gas Replacement System (GRS) 100 using an NH₃ dissociation to provide a list gas for a balloon 112. The GRS 100 may include, among other things, an ammonia (i.e., NH₃) supply tank 104, a reactor 102 that is operable to dissociate the ammonia, a heater 118 that is operable to heat the reactor 102, a power supply 120, and a controller 110 that is operable to direct the reactor 102 to dissociate at least a portion of the liquid ammonia into a lift gas comprising nitrogen and hydrogen. In this regard, the controller 110 may direct the heater to heat the reactor 102 to dissociate the ammonia.

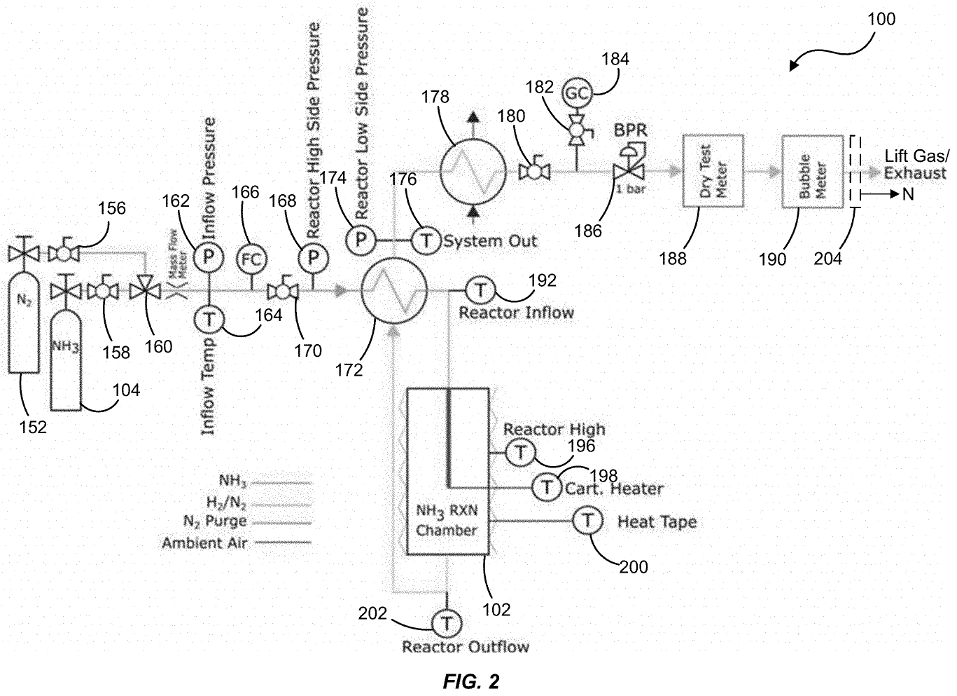

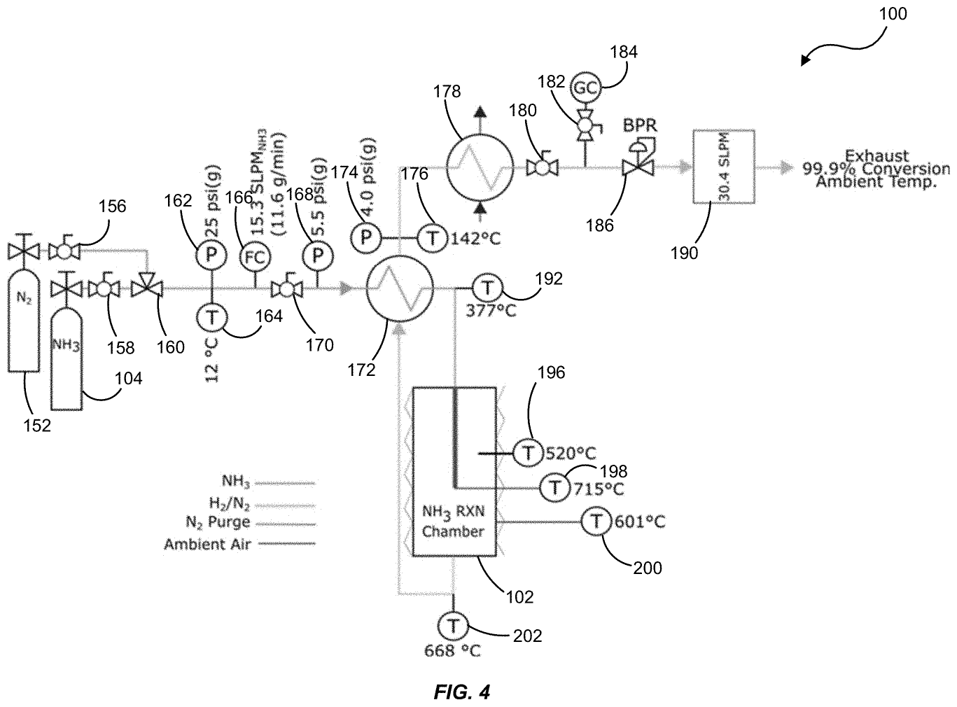

The controller 110 may also control a valve that exhausts the lift gas from the reactor 102 into a balloon 112 for inflation. The controller 110 may also be used to control various other aspects of the GRS 100, such as gas flow meters, back pressure regulators, heat exchangers, various other valves, heaters, and the like. In some embodiments, the controller 110 may be part of a payload 116 (e.g., scientific equipment, altimeters, balloon pressure sensors, etc.) configured with the balloon's gondola 106 so as to control and/or process information from the GRS 100 as well as the various components of the payload 116. A more detailed exemplary embodiment of the GRS 100 is shown and described below in FIGS. 2 and 4.

The GRS 100 may produce lighter than air lift gas by dissociating all or part of an ammonia supply into a mixture of nitrogen, hydrogen, and ammonia, which can be done using a heated catalytic reactor 102 or other means. The GRS can be used to launch the balloon 112 from the ground and/or produce gas 108 for an airborne balloon 112, such as an SPB, to extend their flight duration. The GRS 100 can extend the duration of flights of the balloon 112 at nearly constant altitude by employing liquid ammonia stored aboard the balloon's gondola 106 and using it to replace helium 114 that leaks from the balloon 112. The ammonia can be used directly as a helium replacement gas, or it can be dissociated into a low molecular weight nitrogen/hydrogen mix. In either case, the balloon 112 remains inflated and remains floating at nearly constant altitude.

One advantage of using a storable liquid to produce lift gas in flight rather than the conventional method of dropping ballast is that the consumable mass is greatly reduced. That is, since ballast is less of a factor in maintaining altitude, less ballast is needed which reduces the overall weight of the balloon 112. In some embodiments, ballast is reduced by a factor of 1.7 in a simple non-dissociation system and by up to 3.4 in a dissociation system.

For example, in a traditional ballast-dropping system, the floating mass of the balloon hundred and 12 changes by the sum of the ballast and the leaked helium. However, only the leaked helium is lost in the GRS 100. Thus, the floating mass of the overall system remains almost constant with near constant cruise altitude being maintained as a result. When using the GRS 100, the altitude excursion for a given amount of helium leakage 114 is reduced by a factor of 8 as compared to a traditional ballast-dropping system. And, the GRS 100 provides an elegant low-mass system that uses little power.

The GRS 100 can provide inflation gas for ground-launching of balloons, including latex balloons and zero-pressure balloons. Helium and hydrogen, which are usually supplied as high-pressure gases in heavy storage cylinders, are normally used for balloon inflation. The GRS 100 simplifies the logistics of delivering balloon inflation gas to remote locations and also provides a useful replacement for helium, which is generally expensive and is considered to be a finite resource. The GRS 100 can also be flown aboard zero-pressure balloon gondolas to provide the gas required and to limit altitude excursions during day/night cycles. The ammonia can be considered a form of ballast that is converted to lift gas, thereby substantially reducing the consumable mass as compared to the traditional ballast-dropping systems. That is, the ammonia that is used to produce the lift gas is the ballast.

In some embodiments, the GRS 100 can use ammonia directly as a lift gas, allowing it to provide gas at a rate that is unlimited by power constraints. For example, ammonia as a lift gas has a molecular weight of 17. When used in Earth's atmosphere, which has a molecular weight of approximately 29, ammonia provides a net lift of 12 g for every mole of ammonia used. If ammonia is dissociated ammonia into a mixture of nitrogen and hydrogen without further separation of the nitrogen and hydrogen, the GRS 100 will produce a lift gas with a molecular weight of 8.5 and provide a net lift of 20.5 gm for every mole of ammonia used.

An additional variant of the GRS 100 may involve separating at least some of the nitrogen contained in dissociated ammonia to further reduce the molecular weight of the lift gas. Such separation is possible using an air separation membrane 204. For example, a polysulfone membrane system by may be used to send hydrogen to its permeate while sending nitrogen to its retentate. Use of a such a system could allow for production of nearly pure hydrogen with a molecular weight of 2, or production of a gas mixture similar to helium with a molecular weight of 4. This can allow up to 27 gm of net lift for every mole of ammonia used.

With this in mind, the GRS 100 can use ammonia from an onboard tank to replace helium lost from the balloon 112 instead of dropping ballast. To illustrate, ambient pressure is generally 341 Pa (i.e., 3.4 mb) at a temperature of 258 K. But, ammonia has a much higher vapor pressure than 3.4 mb at 258 K, so all of the ammonia delivered to the balloon 112 will generally turn to gas with a molecular weight of 17. And, every kilogram of ammonia delivered to the balloon 112 displaces 29/17=1.7 kg of air to restore that much buoyancy to the balloon 112. In this regard, 571/1.7=336 kg of ammonia is needed in the above example to maintain full inflation and level float instead of dropping 571 kg of ballast. Additionally, the total floating mass of the system only changes by 91 kg of helium or 1.37% of the total. As a result, the flight altitude only changes by about 100 m.

So, by transferring ammonia from a tank into the balloon, instead of dropping it or any other ballast material, the mass of required consumables to maintain flight can be reduced by more than 40% while the resulting altitude change is cut by a factor of 8.

In some embodiments, different fluids could be used as candidates for GRS replacement gases, examples of such are listed in Table 1. In Table 1, a storage temperature of 258 K generally means that the fluid in question can be stored at ambient conditions, not that it requires 258 K for storage.

TABLE 1
GRS Candidate Fluids

| | Molecular | Ballast Mass | | | | | Pᵥₐₚ | |
|---|---|---|---|---|---|---|---|---|
| Fluid | weight | Fraction | T storage | | P storage | | (258 K) | |
| L:H₂ | 2 | 0.07 | <20 | K | ~1 | bar | Infinite | |
| L:CH₄ | 12 | 0.414 | <114 | K | ~1 | bar | Infinite | |
| NH₃ | 17 | 0.586 | 258 | K | 2.26 | bar | 2.26 | bar |
| Dissociated NH₃ | 8.5 | 0.293 | 258 | K | 2.26 | bar | Infinite | |
| H₂O | 18 | 0.62 | >273 | K | ~10 | mb | 1.65 | mbar |
| H2O/10% NH₃ | 17.9 | 0.616 | 258 | K | 227 | mbar | 227 | mbar |
| H₂O/33% CH₃OH | 22.7 | 0.783 | 258 | K | 3.7 | mbar | 3.7 | mb |
| C₂H₆ | 30 | 1.034 | 258 | K | 16 | bar | 16 | bar |
| CH₃OH | 32 | 1.10 | 258 | K | 8 | mb | 8 | mb |
| Dissociated CH₃OH | 10.7 | 0.369 | 258 | K | 8 | mb | Infinite | |
| Dissociated H₂O/CH₃OH | 12.5 | 0.431 | 258 | K | 4.7 | mbar | 4.7 | mbar |
| C₃H₈ | 44 | 1.52 | 258 | K | 2 | bar | 2 | bar |
| N₂O | 44 | 1.52 | 258 | K | 20 | bar | 20 | bar |
| Dissociated N₂O | 29.3 | 1.01 | 258 | K | 20 | bar | Infinite | |
| CO₂ | 44 | 1.52 | 258 | K | 20 | bar | 20 | bar |

If used in the GRS 100, each of the fluids identified in Table 1 can drastically reduce the flight altitude by the same factor of 8 as ammonia when compared to systems that drop ballast. However, they differ in other respects. For example, the ballast mass fraction column shows how the mass of each of the candidate fluids that is required to compensate for a given amount of helium leakage compares to dropping ballast. Liquid hydrogen (L:H₂) and liquid methane (L:CH₄) both do quite well, but unfortunately, they generally require cryogenic storage. Water works almost as well as ammonia, since its 1.65 mbar vapor pressure that would allow it to replace up to half the helium in the balloon before it condenses. However, water needs to be kept above the ambient temperature of 258 K to avoid freezing. This could be accomplished using a tank warmer. But if such a system and its associated power requirement is to be avoided, an alternative option would be to mix methanol or ammonia with the water. For example, windshield wiper fluid is ⅓ methanol but freezes well below 258 K.

Both pure methanol and 50/50 methanol and water mixtures (i.e., 50% each) can be dissociated into CO₂ and hydrogen, with the resulting gas mixtures having molecular weights ranging from 10.7 to 12.5. The reactions involved are presented in the reaction equations (1) and (2), below:

CH₃OH=>CO+2H₂ ΔH=+130 kJ/mole (1)

CH₃OH+H₂O=>CO₂+3H₂ ΔH=+130 kJ/mole (2)

In one embodiment, the GRS 100 could be configured to dissociate ammonia into hydrogen and nitrogen, producing a gas mixture with a molecular weight of 8.5, via equation (3):

2NH₃=>N₂+3H₂ ΔH=+92 kJ (3)

For each mole of gas produced, the ammonia reaction (3) uses 23 kJ, while the reactions (1) and (2) use 43.3 kJ and 32.5 kJ respectively. Reaction (3) produces gas with a molecular weight of 8.5 while providing 20.5 gm of lift per mole in the Earth's atmosphere. Reactions (1) and (2) produce gases with molecular weights of 10.7 and 12.5, respectively, providing net lifts of 18.3 and 16.5 gm per mole, respectively. If the amount of lift per mole of gas produced is divided by the amount of power needed to produce each mole, reaction (3) provides (20.5/23=) 0.89 gm-lift/kJ, while reactions (1) and (2) provide 0.42 and 0.51 gm-lift/kJ, respectively. It can thus be seen that the ammonia dissociation reaction provides roughly twice the amount of lift per unit power as these alternatives. Thus, it may be preferable to employ reaction (3) as opposed to reactions (1) and (2) for use on high altitude balloons where available power is limited.

Additionally, if a relatively large amount of lift gas is needed quickly, a GRS 100 employing ammonia could use the ammonia in undissociated form as a lift gas, producing a lift of 12 gm/mole, or 0.7 gm of lift per gm ammonia without power limitations. In contrast, the raw methanol employed by reaction (2) is not a lift gas in Earth's atmosphere, while the 50/50 mix of methanol and water employed by reaction (3) only has a lift of 4 gm per mole, or 0.16 gm of lift per gm of fluid. Thus, if rapid generation of lift using undissociated feed fluid is required, ammonia is more than four times as efficient as the methanol/water mix alternative.

With this in mind, the GRS 100 may use NH₃ dissociation to provide a replacement gas with a 8.5 molecular weight. This reaction is generally favored at low pressure. At 1 bar, the equilibrium constant driving it to the right is overwhelmingly favorable, and it improves at 3 mb. This reaction, the reverse of the Haber process, can readily and rapidly be accomplished over an iron catalyst reactor, a nickel catalyst reactor, or a ruthenium catalyst reactor at 400 C (e.g., the reactor 102). In the Haber process, pressures of more than 3000 psi may be needed to drive it in the ammonia synthesis direction. One issue regards providing the requisite energy. For example, if ammonia is burned in air or consumed in a fuel cell, the reaction (4) is highly energetic.

2NH₃+3/2O₂=>N₂+3H₂O ΔH=−445 kJ/mole (4)

One ammonia molecule that is oxidized can provide the energy to dissociate four others. The water product can either be vented or used as float gas itself. Alternatively or additionally, a higher energy fuel, such as propane or another hydrocarbon, might be carried aboard the balloon to provide the energy. Obtaining air to operate a combustor or a fuel cell on a balloon operating at 39 km may be challenging. Thus, as an alternative, ammonia can be dissociated according to reaction (3) using solar power.

The level of power required to drive ammonia dissociation in a reactor built to meet the scale of the requirements of a very large SuperTIGER mission is now described. In this example, replacing 91 kg of helium with an equal volume of an N₂/H₂ mix produced by reaction (3) would use 193 kg of NH₃. If this were done over a 35 day period (e.g., replacing 2% of the helium gas per week), the rate of NH₃ dissociation would need to be about 193,000 gm/[(35days)(24hours/day)(60min/hour)]=3.84 gm/min=0.064 gm/s. Divided by the 34 gm per two moles of ammonia in equation (3) and multiplying by the 92 kJ, this equals 173 W, assuming 24 hour operation. If operation is limited to daylight hours (e.g., assuming 12 hours/day), about 346 W would be needed. This amount of power could be readily supplied by 4 square meters or less of solar panels, with a mass under 20 kg. This is less than 1 percent of the 2700 kg mass of the SuperTIGER gondola. The tradeoff appears to be advantageous given that such a system would replace the need to drop 16.3 kg of ballast per day.

While alternatives exist, ammonia offers the best performance, either as a liquid that is simply injected into the balloon to vaporize, or as a feed for a dissociation reactor. Pure ammonia, however, is quite noxious, and could be chemically incompatible with some balloon materials. Dilute ammonia in water would appear to serve nearly as well as it would take about 10% ammonia in water to lower the freezing point to 258 K and the resulting solution would still have a vapor pressure of 220 mbar. Dilute methanol would reduce chemical compatibility concerns even more. So, if no dissociation is performed, then pure ammonia or ammonia/water solutions appear to be the most promising for use in the GRS 100. If dissociation is performed, then pure ammonia seems to be optimal.

In some embodiments, the GRS 100 can be used to enable ground launch of balloons. For example, grid power, portable generators, combustion, or the like can be used to power dissociation. As human crews launching balloons would not wish to wait hours for the inflation process to be performed, higher power heating systems can be used to inflate the balloons more quickly. A typical outdoor barbecue propane-fired heating system can generate thermal energy at a rate of 55,000 BTU/hour=16 kWt. Assuming that a total heat of 46 kJ is needed to dissociate more than 23 kJ to vaporize each mole of ammonia with a heating efficiency of 75%, 92 kJ will be needed to vaporize and dissociate each mole of liquid ammonia into 2 moles of product gas.

The heat of vaporization for ground launch is included because, at the gas production rates desired (i.e., two orders of magnitude higher than those needed for in-flight makeup gas), ambient thermal is insufficient to vaporize the ammonia. Thus, each mole of lift gas needs 92/44=2.1 kJ, allowing a 16 kWt burner to generate lift gas at a rate of 7.62 l/s, or 457 lpm. Each liter of lift gas produces 0.93 gm of lift. At 457 lpm, the GRS 100 would therefore generate 426 gm of lift per minute, allowing it to inflate and launch a typical weather balloon radiosonde system in less than two minutes. In a passenger balloon with a dry mass and including two passengers of 250 kg, ten such units could be configured together in parallel to produce the lift. Producing lift at a rate of 4.26 kg per minute, the burners would be able to launch the flight in 59 minutes. If it were desired to extend the flight of such a low altitude piloted balloon, a single such unit could be carried aboard the gondola 106 to provide makeup gas as required.

The GRS 100 can also be used to enable balloon flights on other planets. For example, Venus and Mars both have atmospheres predominantly composed of CO2 gas. Both undissociated ammonia and the nitrogen/hydrogen mix produced the by the GRS dissociation reactor 102 can serve as lift gas in a CO2 atmosphere. One promising concept would be to use ammonia for rapid initial inflation of a balloon without power limitations during atmospheric descent, and then use the reactor to produce superior nitrogen/hydrogen mixture lift gas to enable extended duration flight.

In some embodiments, the GRS 100 carries ammonia in the tank 104 as a liquid under its vapor pressure. The GRS 100 vaporizes the ammonia by reducing its pressure or heating it to dissociate all or part of the ammonia in the reactor 102 and to deliver product gas through a tube to the balloon 112. Dissociating the ammonia to form nitrogen and hydrogen prior to delivery of the gases to the balloon 112 may be included to reduce the mass of ammonia necessary to replace the volume of gas lost from an SPB by a factor of two.

Dissociation of ammonia may be implemented in a catalytic reactor (e.g., the reactor 102) by providing sufficient heating power to drive an endothermic dissociation reaction. The heat can be provided either by electrical heaters, by a combustion system, or the like. Heat exchange and insulation may be used to reduce the requisite power input. Pressure, temperature, and flow rate controls may be included to provide delivery of the replacement gas under conditions that are compatible with SPBs and their associated subsystems. Alternatively or additionally, ammonia may be delivered without dissociation.

In one embodiment, the GRS 100 employs a stainless steel reactor (e.g., the reactor 102) with, for example, a 2-inch diameter and a 0.065 inch wall thickness. A 0.5 inch diameter cartridge heater may be installed at the top of the reactor, which is where the NH₃ gas feed may be let in. The reactor may also have an electric external shell heater and may be filled with a ruthenium on alumina catalyst.

A relatively large diameter cartridge heater can provide sufficient surface area so that the heat of reaction can be provided directly to the catalyst near the ammonia gas inlet while reducing the load on the external shell heater. This arrangement may also assist in reducing heat losses from the shell to its surroundings. In some embodiments, the 0.5-inch diameter GRS cartridge heater is about 8 inches long and rated at 1000 watts at 120 volts. It may be equipped with an internal K-type thermocouple, which is used to control the maximum heater temperature (760° C.) during heat up and operation. The cartridge heater may be installed at the ammonia gas inlet to provide reaction heat in an optimal location. A six-foot by 0.5-inch external heating tape may be installed on the shell (e.g., 468 watts rating at 120 volts). And, the shell heater may be installed to concentrate most of the heat near the ammonia inlet.

In some embodiments, a GRS heat exchanger (e.g., shown below in FIG. 2) comprises a 51 inch “tube-in-tube” unit configured in a serpentine shape for installation flexibility. The heat exchanger allows relatively hot reactor effluent gas to be used to heat incoming NH₃, reducing the power requirement while cooling the hot gas prior to entry to the balloon. Downstream of the heat exchanger is a heat dump to assure adequate cooling is provided by a coil of 0.25-inch diameter tubing.

FIG. 2 is another block diagram of the exemplary GRS 100. In this embodiment, the GRS 100 includes, among other things: an ammonia tank 104; a reactor 102; heat exchangers 172 and 178; a mass flow controller 166; a gas controller 184 (e.g., implemented by the controller 110 of FIG. 1); a back pressure regulator 186; a dry test meter 188; a bubble meter 190; an optional air separation membrane 204; an optional nitrogen supply tank 152; various valves 156, 158, 160, 170, 180, and 182; various pressure sensors 162, 168, and 174; and various temperature sensors 164, 176, 192, 196, 198, 200, and 202.

For illustrative simplicity, the controller 110 and power supply 120 are not shown. However, when lift gas generation is necessary (e.g., during flight and/or during takeoff), the controller 110 powered by the power supply 120 may open the valve 158 to supply ammonia from the ammonia supply tank 104 to the reactor 102. The mass flow controller 166 may monitor the flow of the ammonia from the supply tank 104 to the reactor 102 in accordance with any of the embodiments shown and described herein to ensure that the desired amount of lift gas is provided to the balloon 114. For example, the mass flow controller 166 may monitor the flow of the ammonia to the reactor 102 and communicate with the controller 110 to adjust the valve 170 accordingly.

The reactor 102 may dissociate the ammonia into the nitrogen and hydrogen lift gas by heating the ammonia and the reactor. In this regard, the reactor 102 may include heating elements (e.g., the heater 118 of FIG. 1) as discussed herein, and the controller 110 may direct the heating elements to heat the reactor 102 such that the ammonia may be dissociated into nitrogen and hydrogen. Once the ammonia is dissociated, the controller 110 may exhaust the nitrogen and hydrogen as lift gas from the GRS 100 via the valve 180 and into the balloon 112.

The various pressure and temperature sensors of the GRS 100 may be used to monitor the ammonia dissociation process of the GRS 100 as discussed herein. The dry test meter 188 may be operable to detect the elements of the exhaust gas from the reactor 102. And, the bubble meter 190 may be operable to measure the flow rate of the lift gas being exhausted from the GRS 100. The heat exchangers 172 and 178 may be operable to reduce the power requirements used in heating the reactor 102 in manners that are exemplarily shown and described herein. In some embodiments, the GRS 100 includes an optional nitrogen (N2) tank that may be used to supply nitrogen to the ammonia via the valve 156 and the three-way valve 160, as exemplarily shown or described herein.

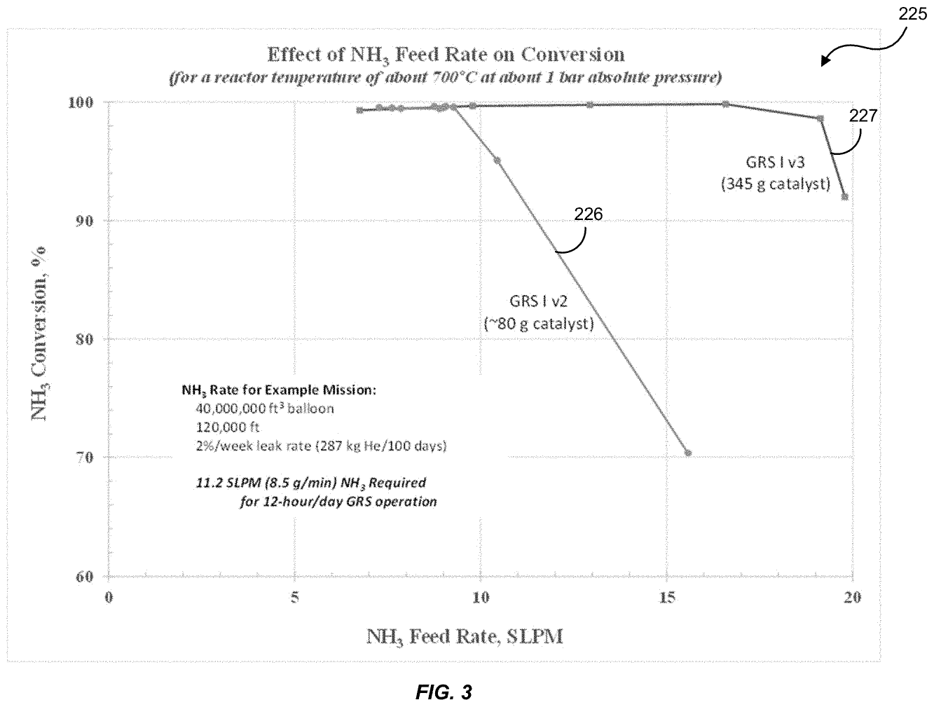

Initial experiments conducted with the GRS 100 were aimed toward establishing a maximum ammonia conversion rate. During those experiments, the ammonia feed rate was incrementally increased, and exhaust gas samples were taken to establish dissociation performance. In this regard, FIG. 3 is a graph 225 illustrating the effect of an exemplary ammonia feed rate on dissociation of the GRS 100.

More specifically, FIG. 3 shows the effect of an ammonia feed rate on dissociation of the GRS 100 (plot line 227) with a comparison to results obtained from an earlier GRS reactor system (plot line 226). The larger and more recent GRS 100 provides virtually complete conversion at nearly double the rate of the previous GRS 100. It should be noted that for both cases, limitations on thermal power input led to reduced performance at the highest ammonia feed rates. For example, the typical reactor exhaust temperature at nearly full conversion is about 700° C. The data points for the two highest flow rates shown for the GRS 100 results 227 exhibited exhaust gas temperatures of only 571° C. and 523° C. This suggests that the GRS 100 can be further refined to achieve high conversion at high flow rates if additional measures to provide sufficient thermal input to accommodate endothermic dissociation reaction are implemented.

In one embodiment, the GRS 100 was demonstrated in an experiment to illustrate its operating characteristics while also using product gas to inflate a latex balloon (e.g., the balloon 112. Along with a parachute, a payload included, among other things, a camera, a GPS tracker, and a satellite/internet relay. The GRS 100 was attached to a 1200 gram balloon and launched. The balloon and payload achieved a burst altitude of about 107,000 feet and were successfully recovered as described below.

FIG. 4 shows the GRS 100 conditions during a ground launch demonstration. In this embodiment, after preheating the reactor 102, ammonia was introduced at a rate of 11.6 grams per minute (15.3 SLPM). As shown in FIG. 3, the ammonia feed rate used would be more than that required to support make up gas for a 40,000,000 cubic foot SPB leaking at a rate of 2 percent per week at 120,000 feet. Ammonia conversions of 99.8 to 99.9 percent were maintained throughout a 95-minute balloon filling operation.

The gaseous ammonia pressure from the ammonia supply tank 104 was regulated to 25 psig 162 as feed to the GRS mass flow controller 166. Ammonia was metered through the mass flow controller 166 at a pressure of 5.5 psig 168. A pressure drop of 1.5 psig was taken through the heat exchanger 172 and the reactor 102, discharging at 4 psig. A mechanical backpressure regulator 186 was set to provide between about 2 and 4 psig, which was sufficient to deliver the dissociated GRS product gas through a dry test meter 188 and about 80 feet of 0.5-inch inside diameter tubing to the latex balloon (e.g., the balloon 112), the dry test meter 188 being operable to detect the elements of the exhaust gas from the reactor 102.

The temperature of gaseous ammonia delivered to the mass flow controller 166 was 12° C. The temperature of the ammonia was elevated to 377° C. in the heat exchanger 172 by hot reactor exhaust gas, which was cooled to 142° C. in the heat exchanger 172. The reactor shell and cartridge heaters provided additional thermal power needed to boost the ammonia temperature to the 700° C. range while also supplying the required thermal input to support the heat of reaction. Heat remaining in the reactor exhaust after the heat exchanger 172 was cooled to ambient temperatures in a coil of stainless steel tubing upstream of the backpressure regulator 186.

Samples of the dissociated gas were taken every 10 to 15 minutes to verify ammonia conversion. The product gas contained between about 463 and 1025 ppm NH₃ throughout the balloon filling period, corresponding to ammonia conversions between about 99.8 and 99.9 percent.

Power inputs measured during the GRS 100 demonstration showed about 1090 watts were applied to the GRS 100. This was about 39 percent greater than the theoretical thermal power input requirement of about 784 watts. Of the theoretical thermal power requirement, about 611 watts were required for ammonia dissociation while 173 watts were required to heat the feed ammonia from 377° C. (i.e., the heat exchanger exhaust temperature measurement 192) to the reactor exhaust temperature of 668° C. (i.e., the reactor temperature measurement 202). Roughly one half of the actual power input was provided by the internal reactor cartridge heater 198. Remaining thermal power input was provided by the external reactor shell heater (i.e., the reactor temperature measurement 200).

Additional power input reductions can be achieved through improved insulation and better heat exchange between the GRS exhaust gas and feed ammonia. For example, the heat exchanger 172 reduced the temperature of the exhaust gas to 142° C. while preheating the feed ammonia to 377° C. (i.e., the temperature measurement 192). An efficient, compact heat exchanger could be used to improve gas preheating to significantly reduce the gas preheating requirements. This would be particularly helpful in the operation of the GRS 100 on a SPB flight in which ambient temperatures would be in the −40° range.

In one actual reduction to practice, lift gas was produced as described above and delivered to a 1200 gram latex balloon. During the 95 minute inflation period, about 131 cubic feet (3709 liters) of gas was delivered to the balloon from the GRS 100 at a temperature of about 21° C. and 0.83 bar absolute pressure, including a relatively small amount of backpressure exerted by the balloon and 80 feet of 0.5-inch diameter tubing. The average fill rate was approximately 39 standard liters per minute, somewhat larger than the stated requirement for supporting a 40 million cubic feet balloon. After filling, the balloon lift was measured to verify proper filling, and the parachute and payload were attached in preparation for launch. The 800 grams of mass lifted by the balloon included, among other things, a parachute, a camera, a payload frame, a GPS, a flight computer, insulation, and battery packs.

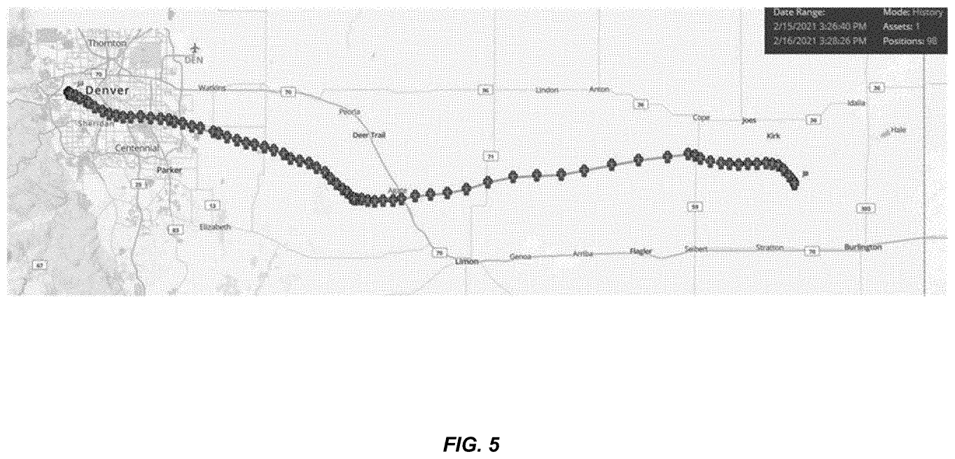

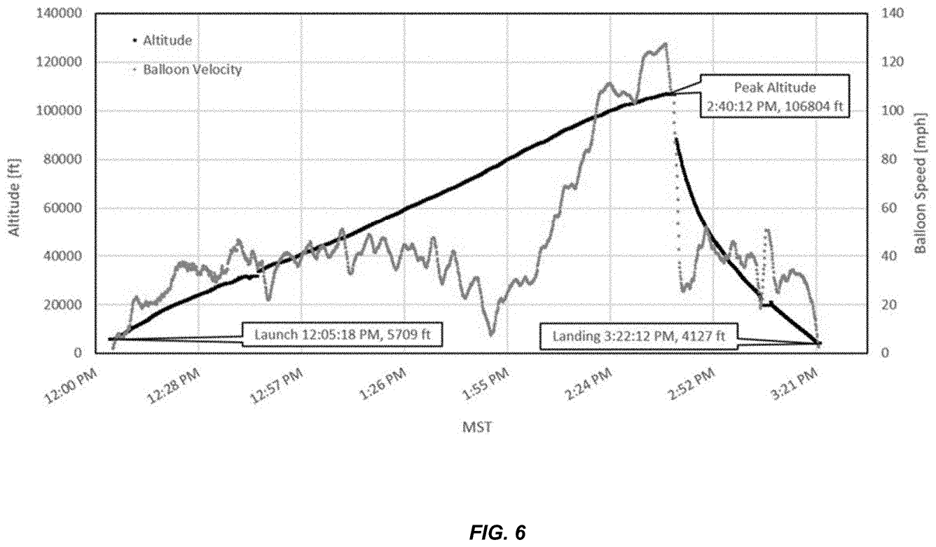

The balloon ascent rate was about 700 feet per minute. After ascending through the polar vortex at 95,000 feet, the balloon accelerated to 128 miles per hour, and reached a burst altitude of about 107,000 feet. The gondola was then successfully recovered shortly after landing in eastern Colorado. FIG. 5 shows the demonstration flight ground track, and FIG. 6 shows the balloon altitude and speed during the flight.

As mentioned, one important parameter of the GRS 100 to maintain flight is the balloon leak rate. Because the GRS 100 is based on a volumetric replacement for lost helium, the GRS 100 may be operated to match the leak rate by operating daily to produce dissociated ammonia gas. The GRS 100 could be operated continuously to maintain a precise balloon pressure by matching its rate to the instantaneous leak rate. However, periodic operation during daylight hours when leakage is greatest and solar energy is available contributes to overall system efficiency.

There are several considerations that enter into the design of the GRS 100 to provide the replacement gas at minimal mass, volume, power, and risk. A summary of the design and operational parameters is presented with respect to SPB mission profiles for context. This preliminary systems analysis facilitates the path toward further refinement and optimization by identifying design parameters that exhibit sensitivity to feed rate, operational profile (e.g., startup, operation, shutdown, and flight termination), and environmental conditions. Other factors such as controls, interfaces, and safety measures are also considered for successful implementation.

The GRS reactor 102 is generally quite compact and flexible in its configuration and would be capable of fitting on a gondola without interference with other hardware or experiments. The GRS 100 would generally consist of an ammonia supply tank 104, a reactor 102, controls, power supply, and product gas delivery tubing. The ammonia tank can be positioned near the reactor 102 via flexible tubing to provide mounting options. The lift gas from the GRS 100 may be delivered to the balloon from the reactor 102 through segmented tubing of roughly 300 feet (90 meters). Thermal controls to accommodate environmental conditions from launch through operation may also be included. Venting and means to verify safe decommissioning at mission termination may also be employed.

The example missions summarized in Table 2 below were used to prepare a preliminary profile of GRS mass, power, and volume specifications. Example missions were set at 100 days for comparative purposes. The balloon leak rate, volume, replacement rate, and other data are also shown in Table 2.

TABLE 2
GRS Specifications for SPB Missions

| | Example 1 | Example 2 |
|---|---|---|
| GRS Mission | (Initial | (Larger |
| Parameters | Evaluation) | Scale) |
| Balloon Altitude, m | 32,000 | 36,588 |
| Balloon Altitude, ft | 104,987 | 120,039 |
| Air Density, g/m³ | 13.6 | 6.4 |
| Absolute Pressure, mbar | 8.68 | 4.46 |
| Temperature, K | 229 | 241 |
| Balloon Volume, ft³ | 19,000,000 | 40,000,000 |
| Leak Rate, % per week | 0.68 | 2 |
| Leak Rate, kg He/100 days | 98 | 287 |
| NH₃ Rate, g/min | 2.9 | 8.5 |
| NH₃ Rate, SLPM | 3.8 | 11.2 |
| kg NH₃/100 days | 211 | 618 |

The g/min and the NH₃ SLPM (standard liter per minute) shown above represent operation of the GRS 100 for 12 hours per day (i.e., twice the nominal average daily leak rate). The reactor 102 of the GRS 100 may be configured to accommodate either of the scenarios cited in Table 2. The non-optimized mass of the GRS 100 including the reactor 102 (with catalyst), heat exchanger 172, cooling coil, isolation valves, and framework was about 5 kg. Even with mass allowance for insulation, instrumentation, shell heater, and controls, the mass of the GRS 100 should be relatively small compared to the mass of ammonia used to support missions such as those illustrated above, and very small compared to the almost 6000 kg floating mass of the balloons and mission equipment.

An initial estimate of the mass and volume of the ammonia supply tank 104 was prepared for each case above. The ammonia mass is based on the gas make up rate and is therefore fixed. However, temperature ranges and tank structural parameters have an effect on the storage tank mass and volume. For example, a conservative estimate illustrated below is based on a maximum ammonia temperature of 35° C. (e.g., pre-launch conditions on a hot day). A tank burst pressure of 250 psi was selected for this case. A five percent additional volume allowance was provided to account for vapor head space. The structural specification of the ammonia supply tank 104 is based on a PV/W (pressure*volume/work) of 250,000 inches. This value is representative of a composite engineered tank with a metal liner. Such tanks are capable of achieving PV/W values of greater than 1,000,000 inches, which would reduce the tank mass by a factor of four over the conservative case. However, the conservative value was chosen to approximate specifications that may be used for an SPB payload. In any case, Table 3 below shows that the mass of ammonia far exceeds the tank mass even for the conservative estimate and the tank is assumed to be spherical.

TABLE 3
Ammonia and Supply Tank Mass and Volume

| Ammonia Tank | | |
|---|---|---|
| Parameter | Example 1 | Example 2 |
| NH3 Mass, kg | 211 | 618 |
| NH3 Tank Mass, kg | 10.4 | 30.4 |
| NH3 Tank Volume, L | 376 | 1100 |
| NH3 Tank Diameter, cm | 90 | 128 |

The values of Table 3 are based on maximum temperature of 35° C. and a corresponding ammonia vapor pressure and liquid density. The mass and volume of the ammonia supply tank 104 can be reduced by specifying a lower temperature. This would primarily effect launch preparations by providing ammonia tank cooling until launch. This results in somewhat greater ammonia liquid density (e.g., a lower volume) and reduces the tank pressure requirements. Table 4 shows the effect of temperature on ammonia density and vapor pressure.

TABLE 4
Ammonia Liquid Density and Pressure versus Temperature

| Temperature, | NH3 Liquid Density, | NH3 Vapor Pressure, |
|---|---|---|
| ° C. | kg/L | psia |
| −50 | 0.702 | 5.9 |
| −40 | 0.690 | 10.4 |
| −30 | 0.678 | 17.3 |
| −20 | 0.665 | 27.6 |
| −10 | 0.652 | 42.1 |
| 0 | 0.639 | 62.2 |
| 10 | 0.625 | 89.2 |
| 20 | 0.610 | 124.4 |
| 30 | 0.595 | 169.3 |
| 40 | 0.579 | 225.6 |

If the maximum ammonia storage tank temperature specification were taken as 0° C. instead of the 35° C. temperature for the case cited above, a reduction of tank mass and volume could be achieved for the same mass of ammonia. The same 250,000 inches PV/W and head space allowance used for the initial calculations were applied. However, the burst pressure was selected as 100 psi while using the liquid ammonia density at 0° C. (0.639 kg/L) for the calculated values shown in Table 5 below.

TABLE 5
Ammonia and Supply Tank Mass and
Volume-Lower Temperature Case

| Ammonia Tank | | |
|---|---|---|
| Parameter | Example 1 | Example 2 |
| NH3 Mass, kg | 211 | 618 |
| NH3 Tank Mass, kg | 3.8 | 11.2 |
| NH3 Tank Volume, L | 347 | 967 |
| NH3 Tank Diameter, cm | 87 | 125 |

The values of Table 5 are based on maximum temperature of 0° C. and the corresponding ammonia vapor pressure and liquid density. Comparison of the estimated ammonia tank mass and volume in Tables 4 and 5 show that tank mass is substantially reduced by designing around a lower ammonia tank temperature and its associated liquid density and vapor pressure. The reduction in tank mass for a design temperature of 0° C. instead of 35° C. is mostly due to the reduced burst pressure specification of 100 psi versus 250 psi. The slightly greater density of ammonia at colder temperatures has much less effect on the tank mass and volume calculations. Regardless, these preliminary evaluations show that the mass of the ammonia itself remains much greater than the storage tank mass over a range of potential conditions.

A thermal power analysis was conducted for the two example cases. The thermal power inputs of the GRS 100 comprise ammonia vaporization, pre-heating ammonia to the reactor temperature, and the ammonia dissociation heat of reaction. For this analysis, National Institute of Standards and Technology (NIST) enthalpy values were chosen for examples of ammonia vaporization at −34° C., heating of ammonia gas from −34° C. to a reaction temperature of 700° C., and dissociation of ammonia to hydrogen and nitrogen at 700° C. Offsetting the thermal heat inputs is the heat available from the hot product exhaust of the GRS 100 via the heat exchanger 172 against the feed ammonia.

Table 6 summarizes the gross heat inputs and the offset from cooling the exhaust gas from 700° C. to 0° C. Note that the values in Table 6 reflect operation of the GRS 100 during a nominal 12 hour daylight period each day, and are therefore twice the average power input.

TABLE 6
GRS Thermal Power Summary

| Thermal Power | | |
|---|---|---|
| Parameter, Watts | Example 1 | Example 2 |
| NH3 Vaporization at −34° C. | 66 | 195 |
| NH3 Heating to 700° C. | 94 | 277 |
| Heat of Reaction at 700° C. | 155 | 456 |
| Sub-Total of Heat Inputs | 315 | 928 |
| Heat from Cooling Product | −117 | −345 |
| Gas | | |
| Net Thermal Power Input | 198 watts | 583 watts |

The values shown above represent theoretical values and do not include heat losses. As noted in the above section on the flight demonstration of the GRS 100, actual power input for the non-optimized GRS 100 was 39 percent greater than theoretical. It would be expected that a GRS 100 configured with an optimized insulation and heat exchanger 172 could perform substantially better. The iterations of heat exchanger designs during the GRS development effort led to the conclusion that a compact, highly efficient heat exchanger 172 specifically designed for the purpose could provide substantially reduced heat losses. Holding the ammonia supply tank at temperatures of −30° C. to −40° C. should ensure sufficient pressure to operate the GRS 100 and provide sufficient pressure for balloon inflation. The thermal power inputs of the GRS 100 could be provided to the reactor 102 to support the endothermic heat of the reaction and to the ammonia supply tank 104 to provide heat for vaporization to hold the tank 104 at suitable pressure. Alternatively, liquid ammonia withdrawal could be used to minimize vaporization within the ammonia supply tank 104. This could eliminate the need for tank heating and would allow for more-efficient utilization of the energy contained in the hot GRS exhaust gas.

In some embodiments, that the net GRS thermal power input is supplied by electric heating driven by solar panels during daylight hours using a minimum of power storage. Based on advanced solar power generation systems of 40 kg/kW generated electricity, rough estimates of GRS power system mass were prepared. Some additional power usage may come from periodic operation of the GRS 100 in which heat will need to be provided to make up for losses during idle periods. For initial systems analysis, a 20 percent factor over the theoretical net thermal power input shown in Table 6 accounts for heat losses. Power for instrumentation and controls was applied to the 40 kg/kW value to obtain power supply mass estimates of about 9.5 and 28 kg for Example 1 and 2 of Table 6, respectively. Again, these estimates show that the mass of the ammonia supply is generally the most significant component of the overall system mass. However, the total mass of the GRS 100, including ammonia, represents only a fraction of the total balloon mission mass. The extended flight time and minimized altitude deviations provided by the GRS 100 represent significant benefits to most SPB missions.

Based on this systems analysis, a rough estimate of overall system mass was prepared by summing the mass of components discussed above (e.g., the reactor 102, the ammonia supply tank 104, the power supply, etc.) along with additional allowances for GRS insulation, balloon inflation hose, framework/supports, instrumentation/controls, and GRS-to-balloon system interface hardware and associated valves and controls. This rough estimate projects a system hardware mass of about 50kg and 110 kg for Examples 1 and 2 of Table 6, respectively, and provides a 100-day ammonia supply mass of 211kg and 618 kg for Examples 1 and 2, respectively. The estimated hardware mass for each case is in the range of about 20 percent of ammonia mass.

Refinements to the estimates of GRS power, mass, and volume can be derived from system optimization with consideration of integration with SPB systems. Further work can also help identify methods to minimize power inputs and to minimize other potential consumables mass. For example, laboratory work employed a protocol of purging the reactor system with inert gas prior to shut down. In a mission scenario, the GRS 100 could be purged with inert gas prior to flight to protect the catalyst from oxidation. Each subsequent shutdown could be performed by isolating the reactor 102 in the presence of the dissociated ammonia. This would protect the catalyst from oxidation and would eliminate the requirement for a separate purge system. Appropriate steps for flight termination can be taken to vent any excess ammonia in a controlled fashion with instrumentation to ensure safe conditions.

In summary, the GRS is feasible to support long-duration SPB missions and perform and/or provide the following:

In one embodiment, the Gas Replace System (GRS) provides inflation gases for balloons.

In one embodiment, the GRS dissociates ammonia to produce a mixture of nitrogen and hydrogen lift gas for use in launching balloons from the ground.

In one embodiment, the GRS dissociates ammonia to produce a mixture of nitrogen and hydrogen lift gas for use in extending the duration of flight of a balloon that is already airborne.

In one embodiment, the GRS uses a heated catalytic reactor to dissociate ammonia to produce a mixture of nitrogen and hydrogen lift gas.

In one embodiment, the GRS uses a ruthenium or nickel-based catalyst in a heated catalytic reactor to dissociate ammonia to produce a mixture of nitrogen and hydrogen lift gas.

In one embodiment, the GRS uses a heat exchanger that exchanges heat between the input and output streams of a heated catalytic reactor that dissociates ammonia to produce a mixture of nitrogen and hydrogen lift gas.

In one embodiment, the GRS uses an electric heater to heat a catalytic reactor that dissociates ammonia to produce a mixture of nitrogen and hydrogen lift gas.

In one embodiment, the GRS uses a combustion system to heat a catalytic reactor that dissociates ammonia to produce a mixture of nitrogen and hydrogen lift gas.

In one embodiment, the GRS uses a combustion system fueled by ammonia to heat a catalytic reactor that dissociates ammonia to produce a mixture of nitrogen and hydrogen lift gas.

In one embodiment, the GRS uses a combustion system fueled by hydrocarbon or alcohol, such as propane, gasoline, or ethanol to heat a catalytic reactor that dissociates ammonia to produce a mixture of nitrogen and hydrogen lift gas.

In one embodiment, the GRS dissociates ammonia to produce a mixture of nitrogen and hydrogen lift gas that is 3:1 hydrogen:nitrogen by mole that is fed directly to a balloon.

In one embodiment, the GRS dissociates ammonia to produce a mixture of nitrogen and hydrogen lift gas that is fed to a separation membrane, that removes part of the nitrogen product, thereby producing a lift gas whose hydrogen:nitrogen molar ratio is greater than 3:1 that is then fed to the balloon.

In one embodiment, solar energy is used to provide electricity to heat a GRS reactor, allowing it to dissociate ammonia to produce a mixture of nitrogen and hydrogen lift gas.

In one embodiment, a portable generator is used to provide electricity to heat a GRS reactor, allowing it to dissociate ammonia to produce a mixture of nitrogen and hydrogen lift gas.

In one embodiment, a battery system is used to provide electricity to heat a GRS reactor, allowing it to dissociate ammonia to produce a mixture of nitrogen and hydrogen lift gas.

In one embodiment, ambient air is used to provide oxidizer to a combustion system to heat a GRS reactor, allowing it to dissociate ammonia to produce a mixture of nitrogen and hydrogen lift gas.

In one embodiment, a compressed or liquefied oxygen supply is used to provide oxidizer to a combustion system to heat a GRS reactor, allowing it to dissociate ammonia to produce a mixture of nitrogen and hydrogen lift gas.

In one embodiment, a compressed or liquefied nitrous oxide supply is used to provide oxidizer to a combustion system to heat a GRS reactor, allowing it to dissociate ammonia to produce a mixture of nitrogen and hydrogen lift gas.

In one embodiment, a hydrogen peroxide or other chemical oxidizer supply is used to provide oxidizer to a combustion system to heat a GRS reactor, allowing it to dissociate ammonia to produce a mixture of nitrogen and hydrogen lift gas.

In one embodiment, the GRS employs undissociated ammonia to provide lift gas to a balloon, either alone or in addition to ammonia dissociated to form nitrogen/hydrogen lift gas.

In one embodiment, the GRS is used to inflate and/or sustain the flight of balloons on Venus and/or Mars.

In some embodiments, the heater is an electrical heater powered by an external power source, such as a portable electrical generator and/or the grid.

In some embodiments, the heater is an electrical heater powered by on an onboard power source, such as a battery and/or a photovoltaic power system.

In some embodiments, the heater is a combustion system utilizing a conventional fuel such as a hydrocarbon or an alcohol.

In some embodiments, the heater is a combustion system utilizing ammonia as a fuel.

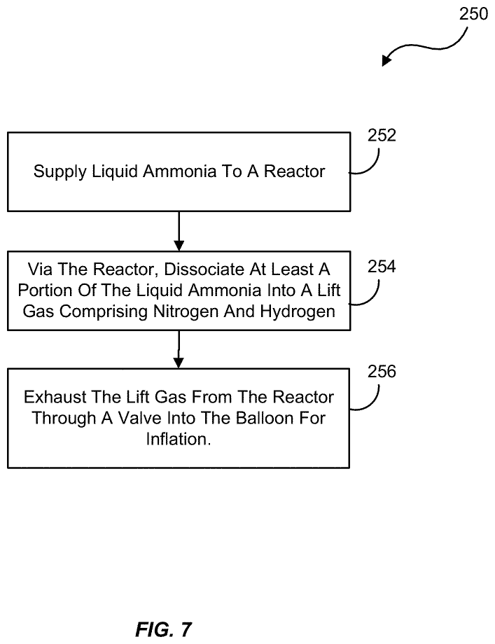

FIG. 7 is a flowchart of an exemplary process 250 operable with the GRS 100. In this embodiment, the GRS 100 may supply liquid ammonia to the reactor 102, in the process element 252. For example, the controller 110 may control one or more valves that supply the liquid ammonia to the reactor 102 when: the altitude of the balloon (e.g., as detected by the altimeter) is below a desired altitude and requires more lift; the gas pressure in the balloon (e.g., as detected by the pressure sensor) is below a desired pressure; the balloon is being initially inflated before launch; etc. The controller 110 may also monitor various pressures within the GRS 100 and control those pressures via one or more valves in the GRS 100, in accordance with any of the process embodiments shown and described herein.

From there, the reactor 102 may dissociate at least a portion of the liquid ammonia into a lift gas that comprises nitrogen and hydrogen, in the process element 254. For example, when the balloon requires lift gas, the controller 110 may start the heater 118 (e.g., a combustion heater that burns some sort of fuel including even liquid ammonia from the supply tank 104, an electric heater, or the like). The heat from the heater 118 may then heat the reactor 102 to dissociate the liquid ammonia into the lift gas. Heat from additional sources may also be used (e.g., heat exchanged from the lift gas exhausted from the reactor 102). The lift gas is then exhausted from the reactor 102, in the process element 256, and into the balloon for inflation.

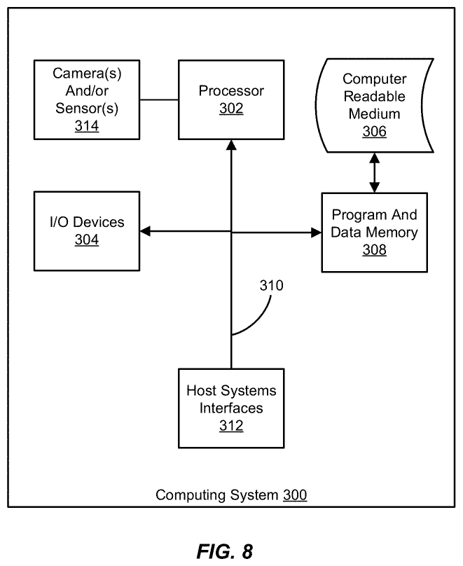

As discussed above, other materials may be alternatively or additionally employed during this process. Additionally, any of the above embodiments herein may be rearranged and/or combined with other embodiments. Accordingly, the GRS concepts herein are not to be limited to any particular embodiment disclosed herein. Additionally, the embodiments can take the form of entirely hardware or comprising both hardware and software elements. Portions of the embodiments may be implemented in software, which includes but is not limited to firmware, resident software, microcode, etc. FIG. 8 illustrates a computing system 300 in which a computer readable medium 306 may provide instructions for performing any of the methods disclosed herein.

Furthermore, the embodiments can take the form of a computer program product accessible from the computer readable medium 306 providing program code for use by or in connection with a computer or any instruction execution system. For the purposes of this description, the computer readable medium 306 can be any apparatus that can tangibly store the program for use by or in connection with the instruction execution system, apparatus, or device, including the computer system 300.

The medium 306 can be any tangible electronic, magnetic, optical, electromagnetic, infrared, or semiconductor system (or apparatus or device). Examples of a computer readable medium 306 include a semiconductor or solid state memory, magnetic tape, a removable computer diskette, a random access memory (RAM), NAND flash memory, a read-only memory (ROM), a rigid magnetic disk and an optical disk. Some examples of optical disks include compact disk-read only memory (CD-ROM), compact disk-read/write (CD-R/W) and digital versatile disc (DVD).

The computing system 300, suitable for storing and/or executing program code, can include one or more processors 302 coupled directly or indirectly to memory 308 through a system bus 310. The memory 308 can include local memory employed during actual execution of the program code, bulk storage, and cache memories which provide temporary storage of at least some program code in order to reduce the number of times code is retrieved from bulk storage during execution. Input/output or I/O devices 304 (including but not limited to keyboards, displays, pointing devices, etc.) can be coupled to the system either directly or through intervening I/O controllers. Network adapters may also be coupled to the system to enable the computing system 300 to become coupled to other data processing systems, such as through host systems interfaces 312, or remote printers or storage devices through intervening private or public networks. Modems, cable modem and Ethernet cards are just a few of the currently available types of network adapters.

What is claimed is:

1. A Gas Replacement System (GRS) for a balloon, comprising:
a tank containing ammonia;
a reactor; and
a controller operable to direct a release of the ammonia from the tank to the reactor, and to direct the reactor to dissociate at least a portion of the ammonia into a lift gas and exhaust the lift gas from the reactor into the balloon for inflation, the lift gas comprising nitrogen and hydrogen.

2. The GRS of claim 1, further comprising:
a valve physically coupled between the tank and the reactor and communicatively coupled to the controller,
wherein the controller is operable to open the valve to release the ammonia from the tank to the reactor.

3. The GRS of claim 1, further comprising:
one or more valves communicatively coupled to the controller,
wherein the controller is operable to control pressure within the GRS by controlling the one or more valves.

4. The GRS of claim 1, wherein:
the GRS further comprises a heater to heat the reactor to dissociate said at least a portion of the ammonia into the lift gas.

5. The GRS of claim 4, wherein:
the heater comprises at least one of an electric heater or a combustion heater.

6. The GRS of claim 1, further comprising:
an altimeter operable to detect an altitude of the balloon,
wherein the controller is operable to direct the reactor to dissociate said at least a portion of the ammonia into the lift gas based on the detected altitude of the balloon.

7. The GRS of claim 1, wherein:
the controller is further operable to direct the reactor to dissociate said at least a portion of the ammonia into the lift gas before the balloon takes flight.

8. The GRS of claim 1, further comprising:
a pressure sensor operable to detect a pressure within the balloon,
wherein the controller is further operable to direct the reactor to dissociate said at least a portion of the ammonia into the lift gas based on the detected pressure within the balloon.

9. The GRS of claim 1, further comprising:
a heat exchanger operable to heat the ammonia from the tank with heated gas from the reactor prior to dissociation of the ammonia by the reactor.

10. The GRS of claim 1, further comprising:
a separation membrane that removes a portion of the nitrogen from the lift gas to configure the lift gas with a molar ratio of greater than about 3 to 1 of hydrogen to nitrogen, respectively.

11. The GRS of claim 1, further comprising:
a power supply comprising one or more of a generator, a solar panel, or a battery to power at least one of the controller, a heater of the reactor, or a payload.

12. A method of inflating a balloon, comprising:
supplying ammonia from a tank to a reactor;
directing the reactor to dissociate at least a portion of the ammonia into a lift gas, the lift gas comprising nitrogen and hydrogen; and
exhausting the lift gas from the reactor into the balloon for inflation.

13. The method of claim 12, further comprising:
processing a control signal to electronically open a valve to release the ammonia from the tank to the reactor.

14. The method of claim 12, further comprising:
processing a control signal to electronically control one or more valves to control pressure during inflation of the balloon.

15. The method of claim 12, wherein directing the reactor to dissociate at least a portion of the ammonia into a lift gas further comprises:
directing a heater to heat the reactor to dissociate said at least a portion of the ammonia into the lift gas.

16. The method of claim 15, wherein:
the heater comprises at least one of an electric heater or a combustion heater.

17. The method of claim 12, further comprising:
detecting an altitude of the balloon; and
generating a control signal based on the detected altitude of the balloon that directs the reactor to dissociate said at least a portion of the ammonia into the lift gas.

18. The method of claim 12, wherein:
performing said directing the reactor to dissociate said at least a portion of the ammonia into the lift gas before the balloon takes flight.

19. The method of claim 12, further comprising:
detecting a pressure within the balloon; and
generating a control signal based on the detected pressure within the balloon that directs the reactor to dissociate said at least a portion of the ammonia into the lift gas.

20. The method of claim 12, further comprising:
exchanging heat of heated gas from the reactor and the ammonia from the tank to heat the ammonia from the tank prior to dissociation of the ammonia by the reactor.

21. The method of claim 12, further comprising:
removing a portion of the nitrogen from the lift gas to configure the lift gas with a molar ratio of greater than about 3 to 1 of hydrogen to nitrogen, respectively.

22. The method of claim 12, further comprising:
powering at least one of a controller, a heater of the reactor, or a payload with one or more of a generator, a solar panel, or a battery.

23. A non-transitory computer readable medium operable in a Gas Replacement System (GRS) and comprising instructions that, when executed by a controller of the GRS, direct the controller to inflate a balloon, by:
directing a release of ammonia from a tank to a reactor;
directing the reactor to dissociate at least a portion of the ammonia into a lift gas, the lift gas comprising nitrogen and hydrogen; and
exhausting the lift gas from the reactor into the balloon for inflation.
